(19) United States
(12) Patent Application Publication
(10) Pub. No.: US 2025/0102357 A1
(43) Pub. Date: Mar. 27, 2025

(54) Explosion-proof spectroscopy system with automatic motorized alignment

(71) Applicant: KineoLabs, Inc., Billerica, MA (US)

(72) Inventors: Walid A. Atia, Jamaica Plain, MA (US); Richard Gibson-Dee, Terra Ceia, FL (US)

(21) Appl. No.: 18/895,942

(22) Filed: Sep. 25, 2024

Related U.S. Application Data
(60) Provisional application No. 63/584,914, filed on Sep. 25, 2023.

(51) Int. Cl. G01J 3/02

(52) U.S. Cl. CPC G01J 3/0291; G01J 3/0289; G01J 3/0208

(57) ABSTRACT

Tunable or swept cat's-eye lasers for spectroscopy that is adapted for direct mounting to a flow cell and/or includes an internal gas cell and is appropriate for installation in adverse environments and capable of automated alignment and installation in explosion proof enclosures.

### RELATED APPLICATIONS

This application claims the benefit under 35 USC 119 (e) of U.S. Provisional Application No. 63/584,914, filed on Sep. 25, 2023, which is incorporated herein by reference in its entirety.

### BACKGROUND OF THE INVENTION

Absorption spectroscopy measures the presence and/or concentration of one or more specie of interest in a sample by passing light through the sample and detecting the absorption at wavelengths of particular spectral absorption features of the specie. Generally, such features are absorption lines that represent the frequency of light corresponding to vibrational, rotational or electronic transitions of molecules of the gas or liquid of interest. Tunable narrow band sources such as lasers provide many advantages for such absorption spectroscopy measurements in that the lasers' narrowband emissions can be tuned to over spectral features to generate high dynamic range signals.

Today, absorption spectroscopy plays a crucial role in the production and distribution of petroleum products, for example. Particularly UV-Visible and infrared spectroscopy are used to analyze the composition of crude oil and its various fractions during refining processes for quality control. This helps ensure the quality and consistency of petroleum products such as gasoline, diesel, and jet fuel. Spectroscopy also helps in detecting and quantifying impurities like sulfur, nitrogen, and metals in crude oil and refined products. This is essential because excessive impurities can affect product performance and compliance with environmental regulations. In catalytic processes, spectroscopy is used to monitor the activity of catalysts. For example, in fluidized catalytic cracking (FCC) units, online UV-Visible spectroscopy can provide real-time data on catalyst performance, helping to optimize the cracking process. Optical spectroscopy is also used to analyze the chemical composition of fuels, including octane and cetane ratings, which determine the combustion characteristics of gasoline and diesel, respectively. It can also be employed for monitoring the quality of petroleum products in pipelines or at the wellhead. By analyzing the spectra of transmitted light, it is possible to detect changes in composition and/or the presence of contaminants.

### SUMMARY OF THE INVENTION

The present invention concerns a tunable or swept laser architecture that is appropriate for applications including spectroscopy. It can further address safety concerns in applications involving explosive environments such as the production and distribution of petroleum products with the inclusion of an explosion proof enclosure.

In general, according to one aspect, the invention features a spectroscopy system, comprising an explosion proof enclosure and a tunable laser in the explosion proof enclosure for generating an output beam for transmission through a sample cell.

In examples, the output beam is transmitted through a window of the explosion proof enclosure to the sample cell.

Some embodiments employ a coupler for coupling a window of the explosion proof enclosure to the sample cell.

In one example, the tunable laser tunes a wavelength of the output beam over the band including 1600 to 1700 nanometers, which is useful to detect compounds with C—H bonds.

Some examples operate in a transflection mode.

Preferably a host computer is installed in the explosion proof enclosure.

In general, according to another aspect, the invention features a spectroscopy method, comprising providing a tunable laser for generating an output beam for transmission through a sample cell and installing the tunable laser in an explosion proof enclosure.

In general, according to another aspect, the invention features a spectroscopy system, comprising a tunable laser generating an output beam, a pointing system for directing the output beam, a sample detector for detecting the output beam after interaction with a sample, and a controller system configured to operate the pointing system to direct the output beam to the sample detector.

The controller system can be configured to monitor a signal from the sample detector and automatically adjust the pointing system to optimize alignment of the output beam.

In general, according to another aspect, the invention features a spectroscopy method, comprising generating an output beam, directing the output beam with a pointing system, detecting the output beam after interaction with a sample, and operating the pointing system to direct the output beam to the sample detector.

A signal from a sample detector can be monitored and the pointing system automatically adjusted to optimize alignment of the output beam on the sample detector.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIGS. 1 and 2 are perspective views of a spectroscopy system constructed according to the present invention;

FIG. 3 shows the electro optic components of the spectroscopy system including the tunable laser and sample detector along with reference detectors;

FIGS. 4 and 5 are perspective views showing the mounting of the base bench on the kinematic mount to enable user controlled and/or automatic pointing of the output beam generated by the spectroscopy system;

FIG. 6 is a perspective view of another embodiment of the spectroscopy system using two kinematically-mounted pointing mirrors enabling remote control of the output beam's position and pointing angle;

FIGS. 7 and 8 are a perspective view and a cross-sectional view of a spectroscopy system according to another embodiment;

FIG. 9 is a perspective view of the source assembly 650;

FIGS. 10 and 11 are perspective views of the source assembly 650 with the DAC system 20 and industrial host computer 22 hidden; and

FIG. 12 is a perspective view of the sample detector assembly.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Also, all conjunctions used are to be understood in the most inclusive sense possible. Thus, the word “or” should be understood as having the definition of a logical “or” rather than that of a logical “exclusive or” unless the context clearly necessitates otherwise. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

It will be understood that although terms such as “first” and “second” are used herein to describe various elements, these elements should not be limited by these terms. These terms are only used to distinguish one element from another element. Thus, an element discussed below could be termed a second element, and similarly, a second element may be termed a first element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

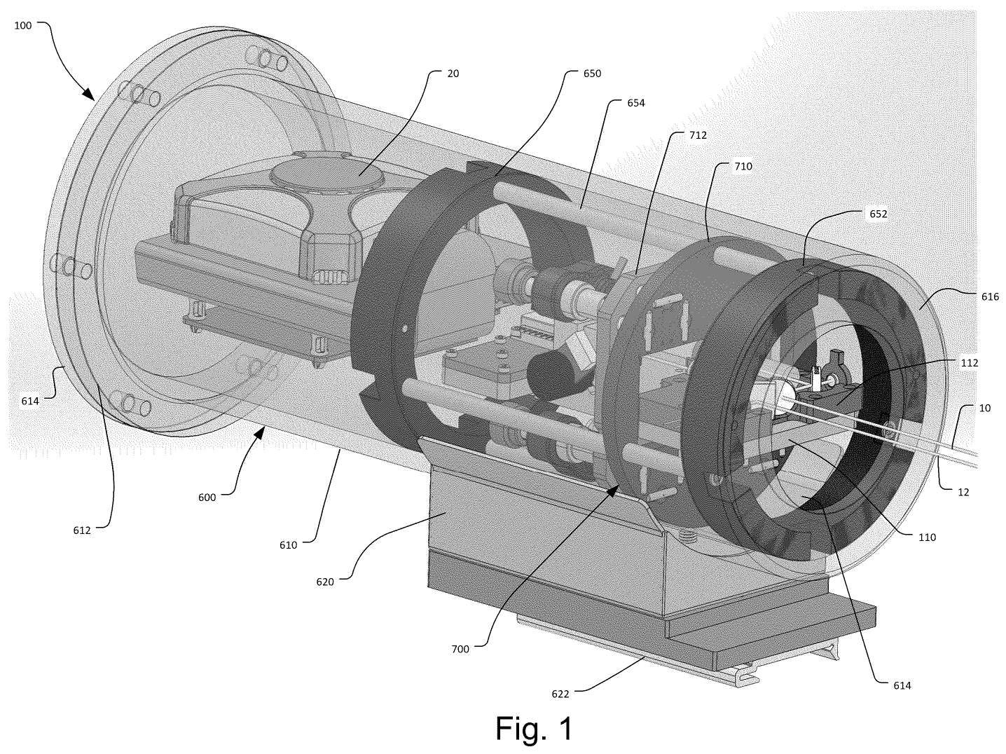

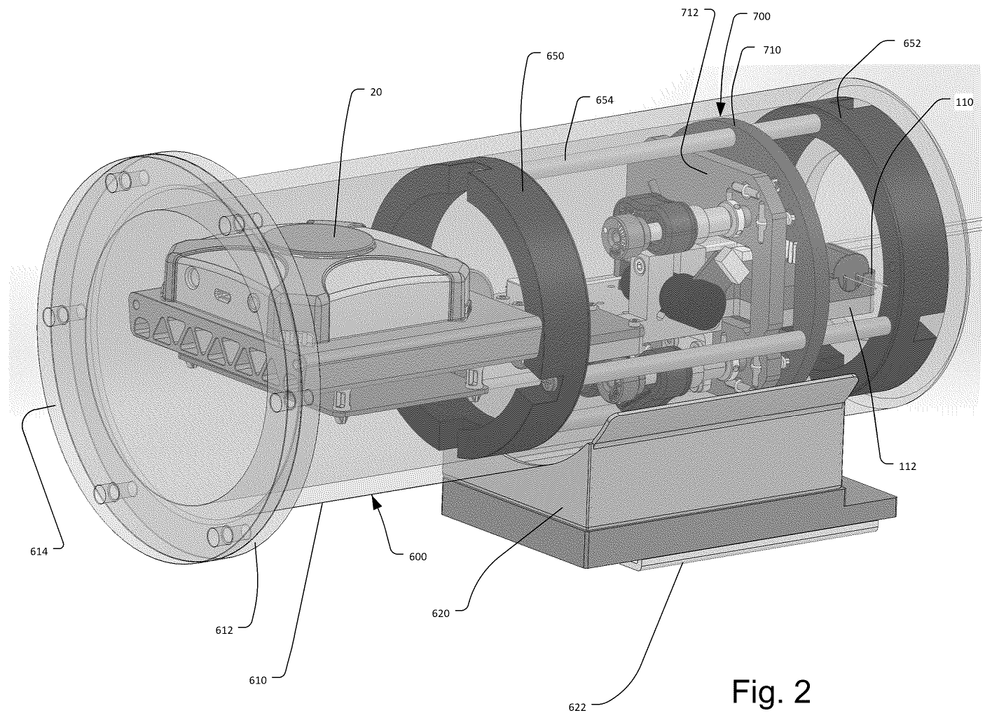

FIGS. 1 and 2 show a spectroscopy system 100 which has been constructed according to the principles of the present invention.

In the illustrated example, the spectroscopy system includes an explosion proof enclosure 600 shown in phantom. The explosion proof enclosure 600 has a generally tubular shaped body 610 and often fabricated from metal such as stainless steel or aluminum. At the back end, an enclosure flange 612 of the body 610 mates to a blind flange 614. The two flanges are typically secured to each other using a series of bolts not shown. The front part of the enclosure 600 includes a front ring 616 that is integral to the tubular section of the enclosure housing 610. The front ring 616 holds a transmissive front window 614 of the enclosure.

In general, the explosion-proof enclosure is a specialized housing designed to prevent the ignition of hazardous gases, vapors, or dust present in industrial environments. These enclosures are critical for safety in environments where flammable materials, such as gases or vapors, may accumulate, such as oil refineries, chemical plants, and other hazardous areas. Their purpose is to contain potential explosions originating inside the enclosure and prevent the ignition of the surrounding atmosphere.

A key concept of the explosion-proof enclosure is that the enclosure does not prevent an explosion from occurring inside the enclosure. Instead, it is designed to contain any internal explosion and prevent it from propagating to the surrounding environment. The design ensures that even if an explosive mixture inside the enclosure ignites, the flame and pressure are contained.

A critical aspect of explosion-proof enclosures is the design of the flame path, which refers to the path that flames must travel to escape from the enclosure. In this example, the flame path is between the enclosure flange 612 of the body 610 and the blind flange 614. Generally, the enclosure's joints and gaps are engineered to ensure that any flame is cooled sufficiently as it travels, so that by the time the hot gases or flames reach the external atmosphere, they are no longer hot enough to ignite the surrounding gas.

These flame paths are typically long and narrow with tight tolerances to facilitate the cooling of the flame and gases.

The illustrated example also includes an enclosure coupling 620 that cradles the enclosure body 610. It can be welded to the body or attached using metal hose clamps. In the illustrated example, the enclosure coupling 620 is used to mount the spectroscopy system 100 to a support such as the illustrated mounting rails 622.

The electro optical components of the spectroscopy system 100 are inserted into the explosion proof enclosure 600 typically by removing the blind flange 614 at the rear and inserting those components into the hollow interior of the enclosure housing 610.

In more detail, a rear mounting ring 650 and a front mounting ring 652 center the components in the housing's internal bore. A series of ring (such as the four shown) standoffs 654 connect the rear mounting ring 650 and the front mounting ring 652.

Supported on the standoffs 654 is a bench kinematic mount 700. Specifically, a kinematic base 710 is held by the four ring standoffs 654.

The bench kinematic mount 700 functions as a pointing system for the output beam 10 and obtaining proper alignment for the return beam 12.

A kinematic platform 712 is supported by the kinematic base 710 in the style of a typical kinematic mount such that the platform can be tilted in each of two spatial axes. This is used to change the angle of an optical base bench 110 that is supported on the kinematic platform 712 in the manner of a cantilever. By controlling the angle of the optical base bench 110 relative to the explosion proof enclosure 600, the direction of an output beam 10, that illuminates a sample contained in a flow cell, for example, is controlled. In addition, in the illustrated transflection arrangement, a return beam 12 is also aligned and guided such that it is coupled to a sample detector, also held by the optical base bench 110.

In more detail, the bench kinematic mount 700 is a precision mechanical device used to support and position optical base bench 110 and its optical elements. It allows for fine adjustment of the orientation of the optical base bench 110 by providing controlled rotation around two axes, here using actuator operated lead screws for adjustment.

The bench kinematic mount 700 enables motion control without introducing unwanted degrees of freedom. The illustrated example uses the three-point contact principle. Ball-and-groove, ball-and-flat, and ball-and-V-groove systems provide three points of contact. These points constrain the movement of the mount, while the screws or actuators allow for precise angular adjustments.

At least two precision screws control tilt (rotation around two orthogonal axes). The screws are usually placed orthogonally to provide decoupled control over the rotation about different axes. Pitch (ex) and yaw (0y) adjustments are commonly achieved through the two main screws. At the contact points, spherical bearings or ball joints are often used. This provides very smooth rotational movement while constraining other unwanted degrees of freedom. Pitch (Rotation around X-axis): Adjusts the angle of the optical element up and down. Yaw (Rotation around Y-axis): Adjusts the side-to-side angle.

Also in the explosion proof enclosure 600 is a controller system 20. This includes a digital processor, digital to analog converters and analog to digital converters for both controlling the spectrometer and monitoring the spectrometer in order to resolve the absorption spectra of a sample being analyzed.

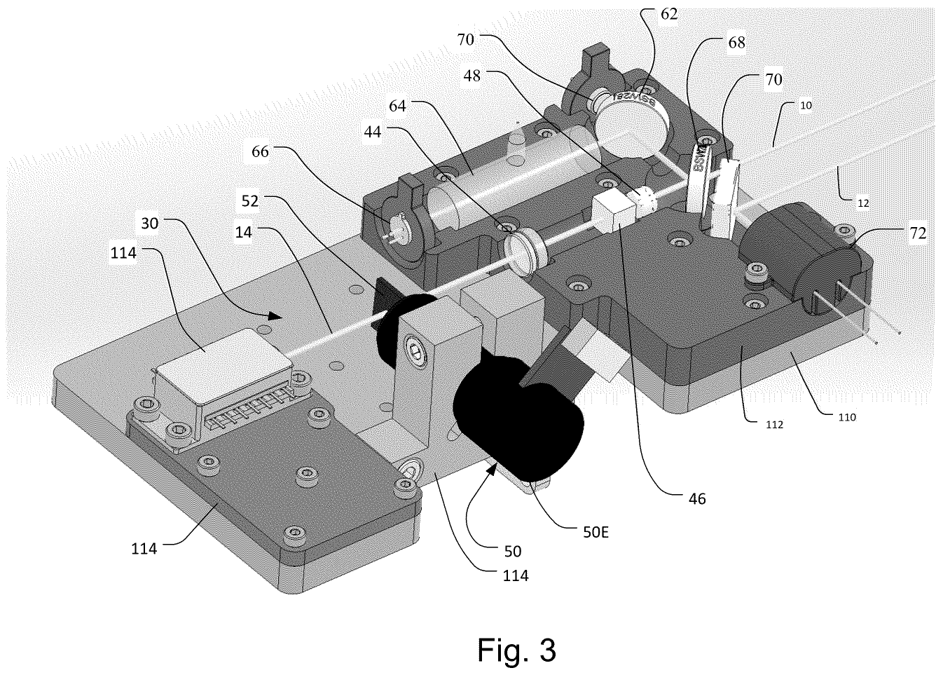

FIG. 3 shows a tunable laser 30 and detectors 66, 70, and 72 and the manner of their construction on the optical base bench 110.

Mounted on the base bench 110 is a package pedestal 114 and an optical upper bench 110. The benches and pedestal are often 3D printed using a filament-fed, FDM 3D printer or a MSLA (Masked Stereolithography) resin 3D printer. In other examples, these benches and pedestal are fabricated from metal such as machined aluminum or possibly anodized aluminum.

A butterfly hermetic package 114 is mounted to the package pedestal 114 and contains a collimation and optical gain assembly. The laser's amplification is provided by an InP gain chip in the illustrated butterfly package 114 or other hermetic enclosure. This package protects the chip from dust and the ambient environment including moisture. In some examples, the package 114 has an integrated or a separate thermoelectric cooler. In the current example, a lens is also installed in the package 114 to collimate the light emission from the gain chip to yield the collimation and optical gain assembly.

Nevertheless, other material systems can be selected for the gain chip according to other examples. Common material systems are based on III-V semiconductor materials, including binary materials, such as GaN, GaAs, InP, GaSb, InAs, as well as ternary, quaternary, and pentenary alloys, such as InGaN, InAlGaN, InGaP, AlGaAs, InGaAs, GaInNAs, GaInNAsSb, AlInGaAs, InGaAsP, AlGaAsSb, AlGaInAsSb, AlAsSb, InGaSb, InAsSb, and InGaAsSb. Collectively, these material systems support operating wavelengths from about 400 nanometers (nm) to 2500 nm, including longer wavelength ranges extending into multiple micrometer wavelengths. Semiconductor quantum well, quantum cascade and quantum dot gain regions are typically used to obtain especially wide gain and spectral emission bandwidths, and support operation up to 250 μm in wavelength. Quantum well layers may be purposely strained or unstrained depending on the exact materials and the desired wavelength coverage.

In one example, the gain chip amplifies light in the wavelength range including 1600 to 1700 nanometer (nm) such as about 1500-1800 nanometers. The preferred chip architecture is termed a single angled facet (SAF) edge-emitting chip. As such, it has a high reflectivity (HR) coated rear facet. It has an antireflective (AR) coated front facet. In addition, for improved performance, it has a curved ridge waveguide that is perpendicular to the rear facet but is angled at the interface with the front facet. This angling at the front facet along with the AR coating reduces reflections at the front facet reflectivity by up to 40 dB and significantly improves laser performance by reducing parasitic reflections that can otherwise lead to non-smooth tuning and mode-hopping.

Preferably its center wavelength is around 1700 nanometers +/−50 nanometers, or more such as preferably +/−100 nanometers.

The free space collimated beam 14 emitted through a front optical window of the package 114 is received by a cat's eye focusing lens 44, which focuses the light onto a cat's eye mirror/output coupler 46. This defines the other end of the laser cavity, extending between the mirror/output coupler 46 and the back/reflective facet of the gain chip in the package 114. Note that in most embodiments, cavity length is between 10 mm and 150 mm in length.

The collimated light between the collimating lens and the cat's eye focusing lens 44 passes through a bandpass interference filter 52 that is angle tuned in the beam by a tilt actuator such as a galvanometer 50.

In the present design, the free spectral range of the tunable filter 52 is preferably greater than 200 nanometer and is preferably over 300 nm such as about 350 nm.

The so-called “effective refractive index” of the tunable filter 52 is preferably greater than 1.50, and is ideally higher than 1.60, such as 1.65.

The passband for the filter is preferably between 1 and 3 nanometers (nm), and more narrowly between 1.5 and 2.5 nm, full width half maximum (FWHM). In one design, it is 2 nm. But, in operation, linewidth narrowing (˜4×) reduces this in the laser cavity for the effective laser linewidth.

These general design parameters yield a large number of longitudinal modes under the envelope for the filter linewidth for a laser cavity length of 50 mm. In the preferred embodiment, there are at least 15 modes under the filter envelope and at least 5 modes for linewidth narrowed emission to 0.5 nm. Ideally, there are at least 25 modes and possibly 37 modes or more and at least 7 modes to 10 or more modes for linewidth narrowed emission.

This is a large number of modes works well for low noise spectral analysis. And keep in mind that the larger the number of modes, the lower the modal noise (by sqrt (number of modes)). However, the amplitude referencing takes out amplitude noise through common mode noise rejection either by digital division or constant power control while sweeping over the tuning range.

The bandpass filter 52 is held on an arm of tilt actuator 50. This allows for tilting of the bandpass filter in the collimated beam to thereby tilt tune the filter and thus change the passband to scan or sweep the wavelength of the swept laser 100.

In the illustrated example, the tilt actuator is a servo galvanometer. In other examples, the angle control actuator 50 is a servomotor or an electrical motor that continuously spins the bandpass filter 52 in the collimated beam 14. This allows for tilting of the bandpass filter 52 with respect to the collimated beam 14 to thereby tilt-tune the filter and thus change the passband to scan or sweep the wavelength of the swept laser.

Tuning speed specifications for galvanometer generally range from 0.1 Hz to 50 kHz. For the higher speeds, a 25 kHz resonant galvo can be used with bi-directional tuning, but higher and lower speeds can be used. Wavelength tuning speed is usually given in nm/sec.

The size of the collimated beam is important for many applications. As a general rule, a smaller beam results in higher divergence resulting in a larger cone half angle (CHA), which is the divergence of the beam hitting the tunable filter. This reduces the minimum line width over angle for a tunable filter. In the current embodiment, the CHA must be smaller than a given amount, typically 0.025 degrees, in order to maintain both linewidth and loss.

Note that a higher divergence beam has a smaller diameter, so this means collimated beams of a large enough diameter are used to provide the required maximum CHA, and larger beams require physically larger tunable filters. A beam size of ˜1 millimeters (mm) is typical for a CHA of 0.025 degrees, but because the beam from the chip is elliptical this should be chosen to be the smaller axis beam. Moreover, we can then choose the final output collimating lens that forms a telescope from the cat's eye focusing lens to have an output beam of whatever desired diameter we would like, with the magnification given by the ratio of the output lens focal length to the focusing lens focal length. Note that if desired the elliptical output beam is circularized with the use of anamorphic prism pairs, a pair of cylindrical lenses, or a simple spatial filter at the output, in different examples.

In any event, the beam size, diameter, of beam 14 for the small axis at the tunable filter 52 is preferably between 0.5 and 2 mm FWHM.

The light from the gain chip is polarized. In the common architectures, the polarization is horizontal or parallel to the epitaxial layers of the edge-emitting gain chip. In the preferred configuration, the filter is oriented to receive the S polarization in order to maintain narrow linewidth of the filter as it is tilt tuned. On the other hand, the P polarization broadens drastically at large tilt angles. S polarization has higher loss at larger tilt angles than P. So, the filter design needs to address these issues by providing a low enough loss across the tuning band for the S polarization.

In general, the present cat's-eye configuration provides a number of advantages. It provides low loss, low tolerance, repeatable stable operation since lower angle wavelength change over grating-based lasers.

The mirror/output coupler 46 will typically reflect less than 90% and preferably about 80% of the light back into the laser's cavity and transmits greater than 10% and preferably about 20% of light. Often, the transmitted light is collimated with the help of an output collimating lens 48. More generally, the mirror/output coupler can reflect from 10% to 99% of light (transmitting 90% to 1%, respectively), depending on the output power and laser cavity loss desired. Higher reflectivity results in lower loss cavities and thus wider laser tuning range where gain exceeds loss, but results in lower output power.

In some embodiments, an iris or mask is added typically after the output coupler to clip the beam edge. This reduces power fluctuations as the beam wanders due to refraction in the tilting bandpass filter.

The portion of the beam passing through the output coupler 46 is collimated by output collimating lens 48 and the collimated beam is typically received by output beamsplitter 68 that directs a portion of the beam to a reference beamsplitter 62. This divides the beam, to send a few percent of the beam to gas cell 64. After passage through the gas cell, the light is then detected by a gas cell detector 66. The transmitted light at the reference beamsplitter 62 is received by an amplitude reference detector 70.

The gas cell is employed for calibration for the detection of the same or similar gas by the system.

In other embodiments, the gas cell is replaced by a different gas cell. Currently, the system is intended to quantify the concentration of methane, so methane is contained in the gas cell, but other gases or mixtures of gases can be contained in the cell. In still another example, the gas cell is replaced with a stable wavelength reference such as an etalon.

For holding the various components, the upper bench 112 has a series of cradles or V-groove optical element mounting locations formed into the top surface.

A galvanometer clamp 114 secures the galvanometer 50 to the optical base bench 110.

Finally, in the illustrated transflection arrangement, a sample detector 72 is further installed on the upper bench 112 to detect the output beam after being modulated by a sample such as a sample contained in a flow cell.

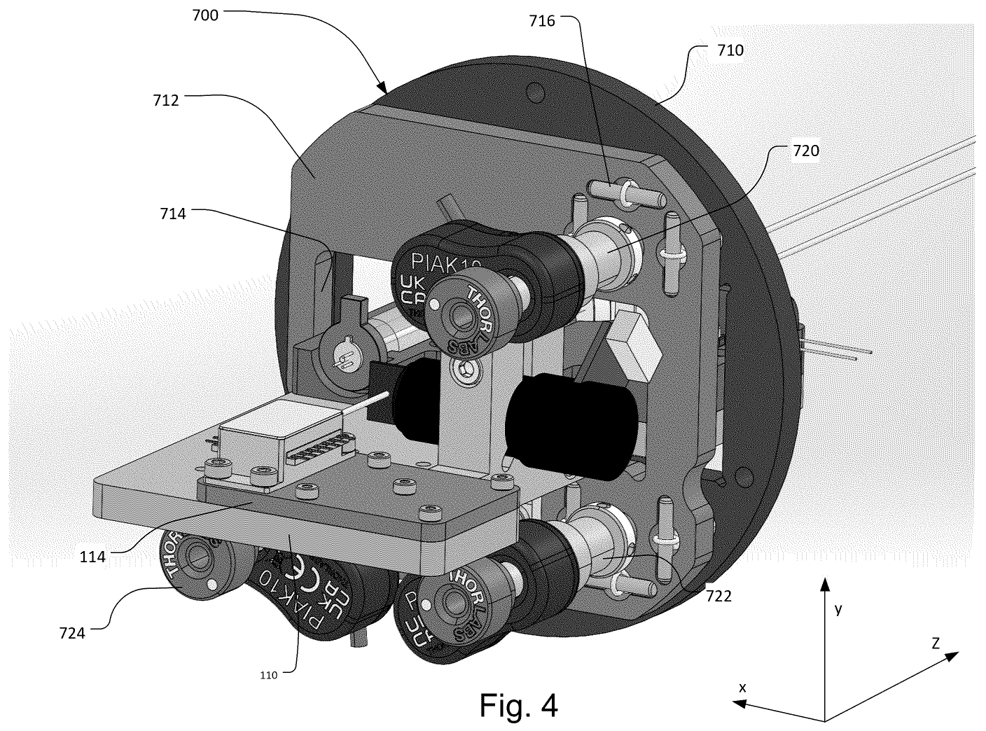

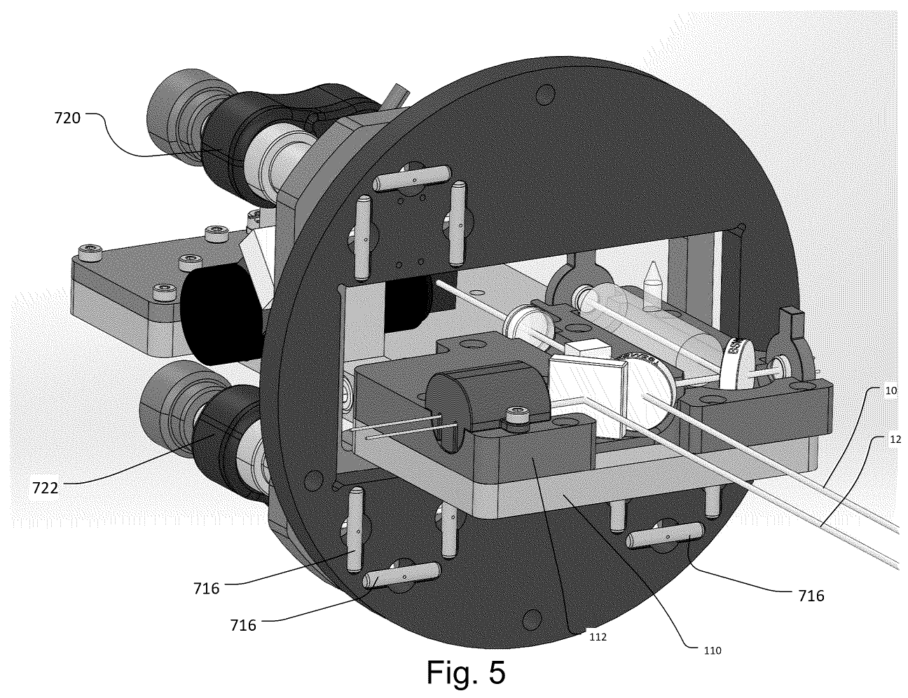

FIGS. 4 and 5 show the kinematic mount 700 and how functions as a pointing system to change the angle of the optical base bench 112 that it carries and thereby change the angle of the output beam 10 from this system 100 such that the output beam 10 illuminates the sample held in the flow cell for example and also ensures that the return beam 12 from the sample and possibly flow cell reach the sample detector 72.

In more detail, a series of lead screw actuators 720, 722, 724 are provided on the kinematic platform 712 and control respective lead screws that engage with the kinematic base 710 to thereby control the spacing and angle between the kinematic platform 712 and kinematic base 710. In addition, as is conventional in kinematic mounts, a series of load springs 716 mechanically load these respective lead screws and drive them into contact with the kinematic base 710.

In more detail, an X axis rotation lead screw actuator 720 controls the spacing between the kinematic platform 712 and the kinematic base 710 to thereby control rotation around the X axis. In a similar vein, a Y axis rotation lead screw actuator 724 at the lower end of the kinematic platform controls the spacing between the kinematic platform 712 and the kinematic base 710 to thereby control rotation around the Y axis. Finally, auxiliary axis rotation lead screw actuator 722 in the other lower corner of the kinematic platform 712 controls the spacing between the platform and the kinematic base 710 to thereby control rotation around the X and Y axes.

In the preferred embodiment, the X axis rotation lead screw actuator 720, Y axis rotation lead screw actuator 724, and the X-Y axis rotation lead screw actuator 722 are controlled by the controller 20. In this way, the system 100 can self-align the output beam 10 to the sample and the return beam 12 to be coupled to the sample detector 72. In particular, the controller 20 monitors the response of the sample detector 72 while controlling the angle of the optical base bench 112 by operating the three lead screw actuators 720, 722, 724. In this way, the system self aligns and realigns itself during operation.

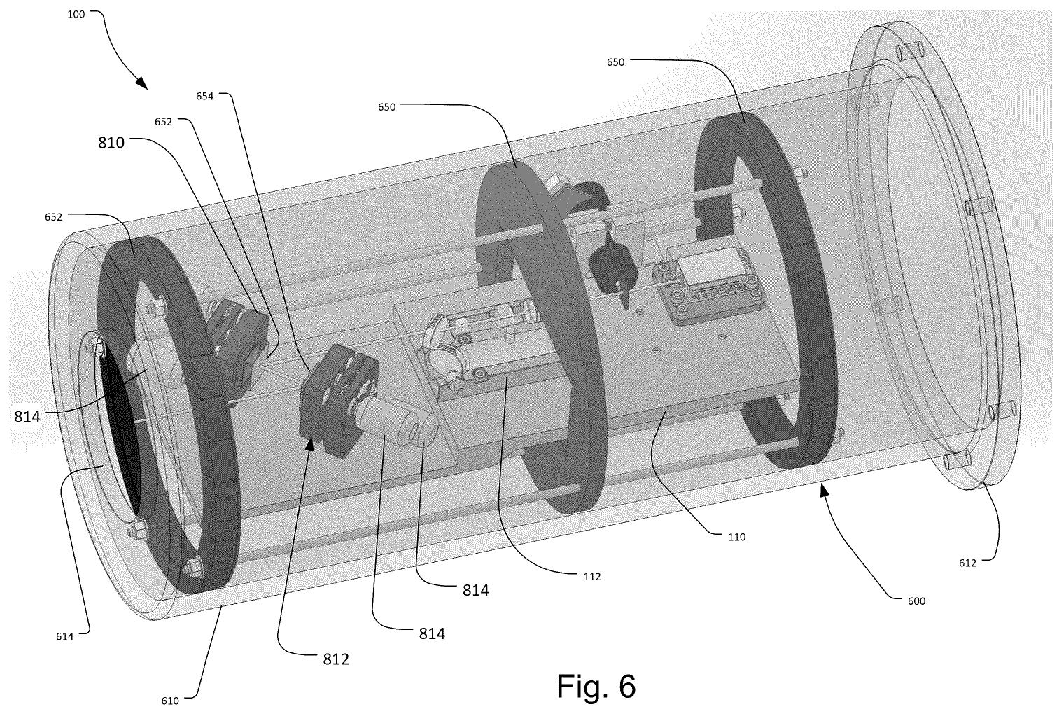

FIG. 6 shows another embodiment of the spectroscopy system 100. In this example, the sample detector is not shown. Instead it is remote from the spectroscopy system 100.

Its pointing system for the output beam 10 includes a first kinematic mount 810 and a second kinematic mount 812. Each of these kinematic mounts holds respective first steering mirror 652 and a second steering mirror 654.

Preferably, the kinematic mounts 810, 814 are controlled by the controller 20 by two lead screw actuators 814 for each of the mounts 810, 814. Therefore, under the control of the controller, the beam can be steered between the two kinematic mounts in order to properly align it with a flow cell by adjusting the beam's pointing angle and position, for example.

The following describes the operation of the foregoing spectroscopy systems.

Upon initial installation, the controller 20 energizes the laser 30 and monitors the light detected by the sample detector. The controller 20 then operates pointing system including the three lead screw actuators 720, 722, 724 shown in FIG. 4 or the four lead screw actuators 814, of the FIG. 6 embodiment, while monitoring the sample detector 72. The controller operates the lead screw actuators to maximize the signal 12 returning from the sample on the sample detector 72.

Once aligned, tilt actuator 50 is preferably operated as a servomechanism by the controller 20. In the illustrated embodiment, the tilt actuator 50 is a servo-controlled galvanometer. An encoder 50E of the galvanometer produces an angle signal indicating the angle of the galvanometer, and thus the filter 52, to the collimated beam 14. Preferably, the encoder is an optical encoder and is often analog.

The controller/processor 20 receives the angle signal at a PID (proportional-integral-derivative) controller implemented in the controller/processor 20. The PID controller compares the angle signal from the galvanometer's encoder 50E to a specified tuning function. Often this tuning function is sawtooth or triangular waveform that is stored algorithmically or in a look up table. This yields feedback control system that corrects for any error in the position. The desired position dictated by the tuning function is compared with the actual position angle control actuator to produce an error signal, which is then fed back to the galvanometer motor via an amplifier to adjust the current and bring the filter 52 to the desired position and control sweeping of the emission of the laser 30 through the desired spectral scan band.

The processor 20 controls the sweeping of the tunable laser 30 and particular a servo galvanometer 50 or other angle control actuator through the laser's tuning range as dictated by the stored tuning function. Preferably, the tuning range is 20 nm or more. More than 60 nm or more than 70 nm is typically preferred. In general, the tuning range should be between 50 nm and 300 nm or more. At the same time, the processor 20 monitors the time response of the sample detector 72 along with the amplitude reference detector 70 and the wavelength reference detector 66 to thereby resolve the absorption spectra of the sample in the sample cell. The processor 20 will typically divide the response of the sample detector 72 by the response of the amplitude reference detector 70 to remove any laser noise such as relative intensity noise (RIN).

In addition, during operation, the controller/processor 20 monitors the level of signal detected by the sample detector 72 when it becomes too low or on a periodic basis, the controller 20 involves an automatic realignment process in which it energizes the laser 30 and monitors the light detected by the sample detector 72. The controller 20 then operates the pointing system such as the three lead screw actuators 720, 722, 724, shown in FIG. 4, or the four lead screw actuators 814, of the FIG. 6 embodiment, while monitoring the sample detector 72. The controller operates the lead screw actuators to maximize the signal 12 returning from the sample on the sample detector 72. This is particularly advantageous when the spectrometer is in an explosion proof enclosure because the enclosure does not have to be opened for an initial alignment and any re-alignment in the field after deployment. Furthermore, since the operation can be done remotely via network connection, a technician does not have to visit the site and possibly get a permit required to open the system on site.

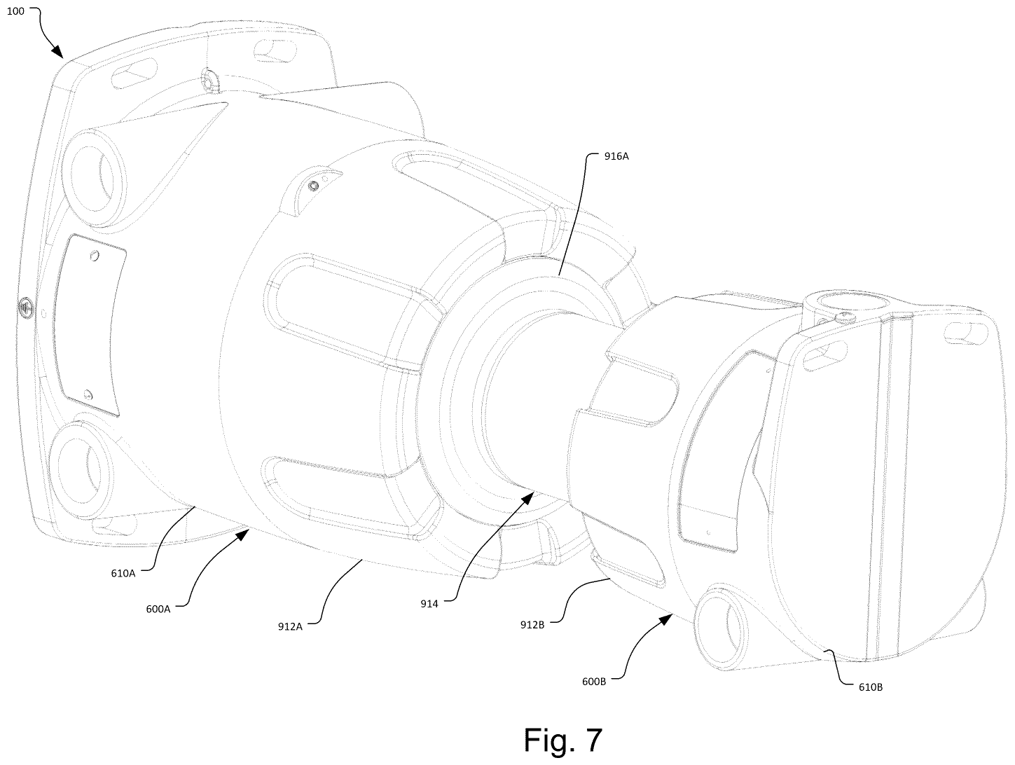

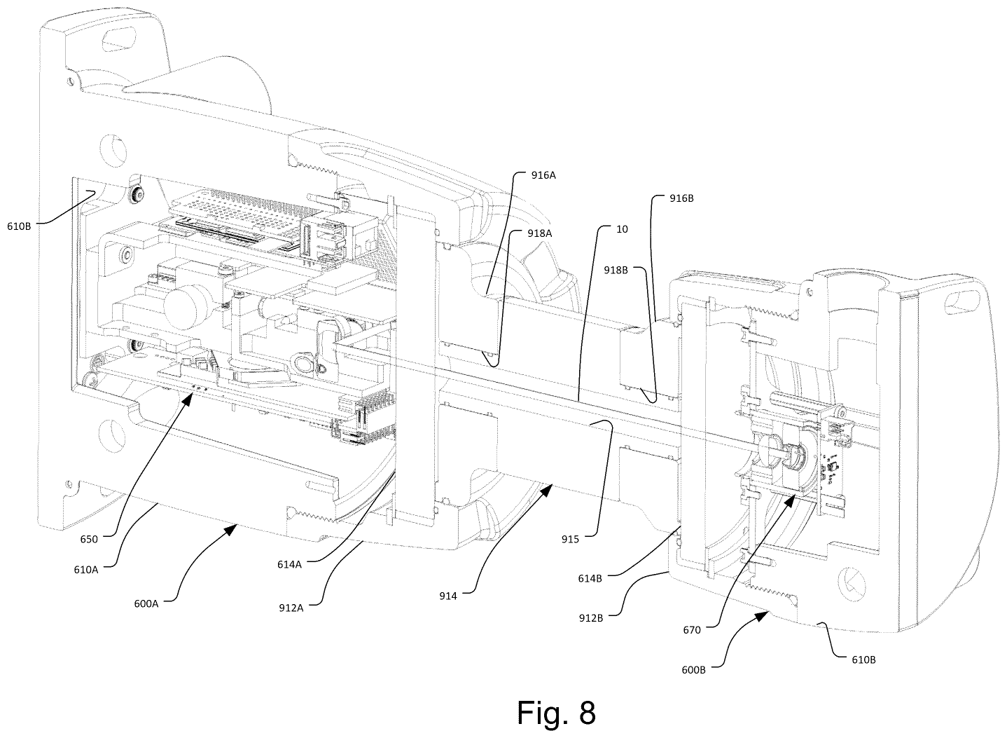

FIGS. 7 and 8 are a perspective view and a cross-sectional view of a spectroscopy system according to another embodiment.

In more detail, this embodiment of the spectroscopy system 100 utilizes a different style of explosion proof enclosure. A source explosion proof enclosure 600A comprises a source enclosure body 610A and a source enclosure windowed cover 912A that screws onto the source enclosure body 610A.

In this transmission example, the sample detector is located in a detector explosion proof enclosure 600B that similarly includes a detector enclosure body 610B and a detector enclosure windowed cover 912B. The sample cell 914 is located between the source explosion proof enclosure 600A and the detector explosion proof enclosure 600B.

In the cross-sectional view, a source assembly 650 is located within the inner bore of the source enclosure 600A. In a similar vein, a detector assembly 670 is located within the detector enclosure 600B.

The light generated by the source assembly 650 is transmitted through the inner volume 915 defined by the sample cell 914. This inner volume 915 contains the fluid, such as gas or liquid that is to be analyzed when the output beam 10 propagates through the fluid and then detected by the detector assembly 670.

Also shown in the cross-sectional view are the enclosure front window 614A of the source enclosure windowed cover 912A. In a similar way, a detector enclosure front window 614B is provided in the detector enclosure windowed cover 912B.

Two couplers 916A, 916B are used to create a stable mechanical and optical coupling between the source explosion proof enclosure 600A and detector explosion proof enclosure 600B. Specifically, the source coupler 916A seals over the source enclosure front window 614A. In a similar manner, the detector coupler 916B seals over the detector enclosure front window 614B. These couplers 916A, 916B seal into the recessed regions of the enclosure windowed covers 912A, 912B covering the respective windows 614A, 614B. Each of the couplers 916A, 916B has a center bore 918A, 918B for receiving the sample cell 914.

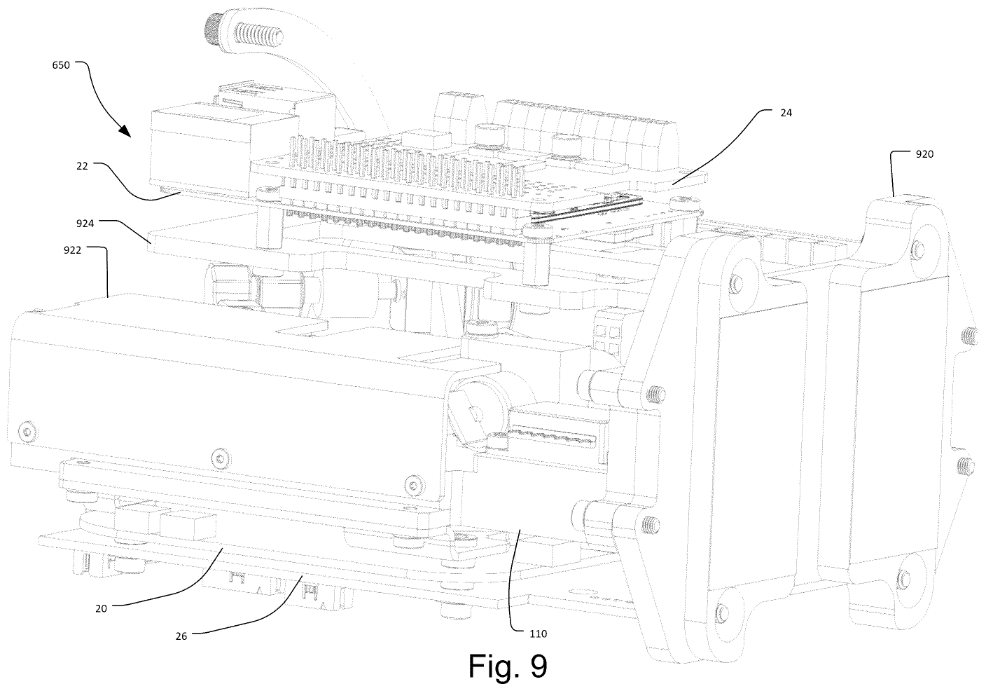

FIG. 9 shows the source assembly 650.

In more detail, the source assembly 650 is mechanically supported by an optical base bench 110 that bolts to a back interface plate 920. The back interface plate 920 in turn is bolted to a rear wall 610B of the source enclosure housing 610A.

An electronics bracket 924 is bolted to the back interface plate 920. It supports and industrial host computer 22. A stepper motor controller 24 in turn is supported on the industrial host computer 22 for controlling the internal stepper motors for the kinematic mount of the pointing system.

In a current example, the host computer is a compact, modular computer designed specifically for integration into embedded systems and industrial applications. It has a full array of I/O ports.

Attached to the underside of the optical base bench 110 is a DAC system 20 along with an analog board 26.

The optical components are held on the top of the optical base bench 110. In the illustrated embodiment, they are largely covered by an optical train cover 922.

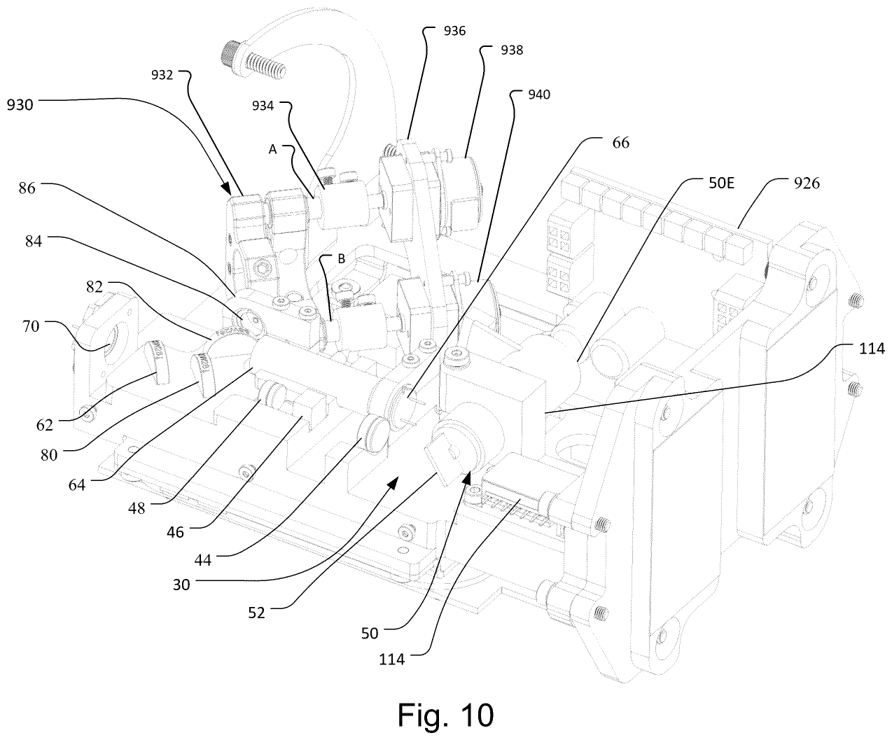

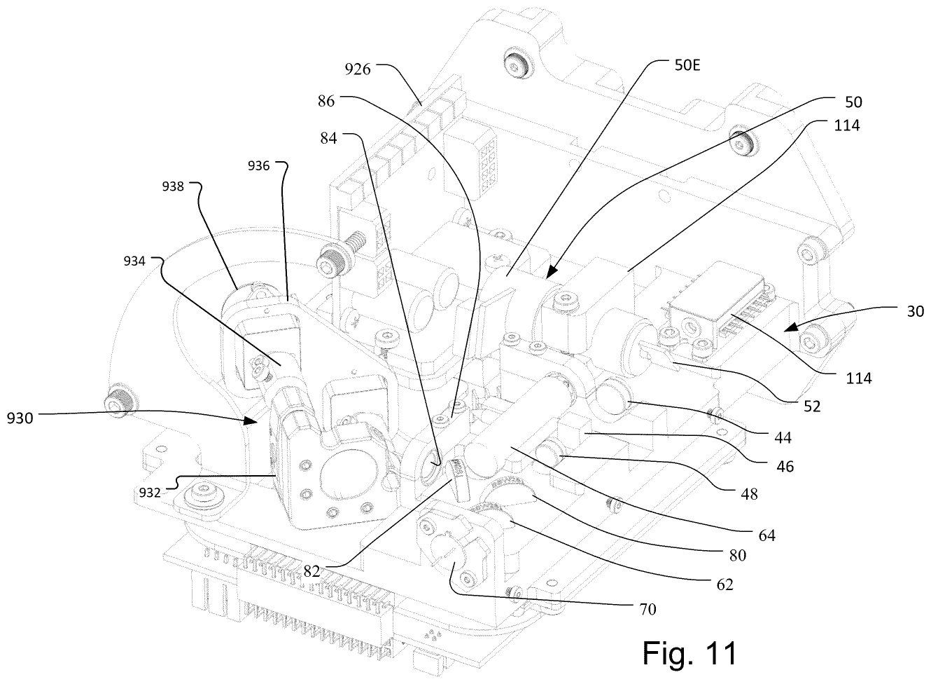

FIGS. 10 and 11 show the source assembly 650 with the DAC system 20 and industrial host computer 22 hidden.

The illustrated embodiment uses the cat's eye laser design discussed previously. In general, the gain chip and collimating lens are contained in a butterfly package collimator assembly 114. The interference filter 52 is held on the angle control actuator which again in this embodiment is a galvanometer 50 with an encoder 50E, which is driven by galvanometer driver board 926. Light passing through the interference filter 52 is focused by the cat's eye focusing lens 44 onto the output coupler 46. Light passing through the output coupler is columnated by the output collimating lens 48. The light is split by a first wavelength reference splitter 80. The transmitted light is received by a second wavelength splitter 82 that divides the light between an etalon detector assembly 84 and a gas cell detector 66. The gas cell or other absolute wavelength reference 64 is placed in front of the gas cell detector 66.

Light that is transmitted through the first wavelength reference splitter 80 is again split by an amplitude reference splitter 62. Light that is transmitted through the amplitude reference splitter 62 is detected by the amplitude reference detector 70. On the other hand, light that is reflected by the amplitude reference splitter 62 is transmitted to a motor kinematic mount pointing assembly 930.

The output beam 10 is directed by the motorized kinematic mount pointing mirror assembly 930. In more detail, this pointing system comprises a kinematic mirror mount 923 that includes two adjustment lead screws A, B. These lead screws are respectively driven by a pitch pointing motor 938 and a yaw pointing motor 940 mounted on a motor mounting plate 936. Two shaft couplers 934 connect the respective motors 938, 940 to the lead screws A, B. In this way, the industrial host computer 22 via the stepper motor controller 24 is able to drive the pitch pointing motor 938 and yaw pointing motor 940 to direct the output beam 10 to transit the sample cell to the sample detector.

In operation, the industrial host computer 22 monitors the response of the various detectors via the analog board 926 that typically includes transimpedance amplifiers for each detector and the DAC system 20 which digitizes the amplified output from the several detectors. Specifically, the instantaneous power of generated by the tunable laser 30 is monitored by the amplitude reference detector 70. This allows the industrial host computer to employ common mode rejection to remove any noise contained in the laser such as relative intensity noise.

The industrial host computer 22 further monitors the gas cell detector 66. The spectral features of the gas contained in the gas cells 64 are generally invariant over temperature. Thus, by monitoring the gas cell detector 66, the host computer 22 is able to calibrate the instantaneous absolute wavelength of the tunable laser 30 as it tunes. The etalon detector assembly 84 includes an etalon and a detector that is also monitored by the industrial computer. The etalon provides a spectral feature that extends across the entire tuning band of the tunable laser's tuning range. Thus, the industrial computer 22 is able to calibrate the laser's tuning across the band even if the etalon has some temperature dependency in its transfer function by reference to the absolute wavelength reference provided by the gas cell detector 66.

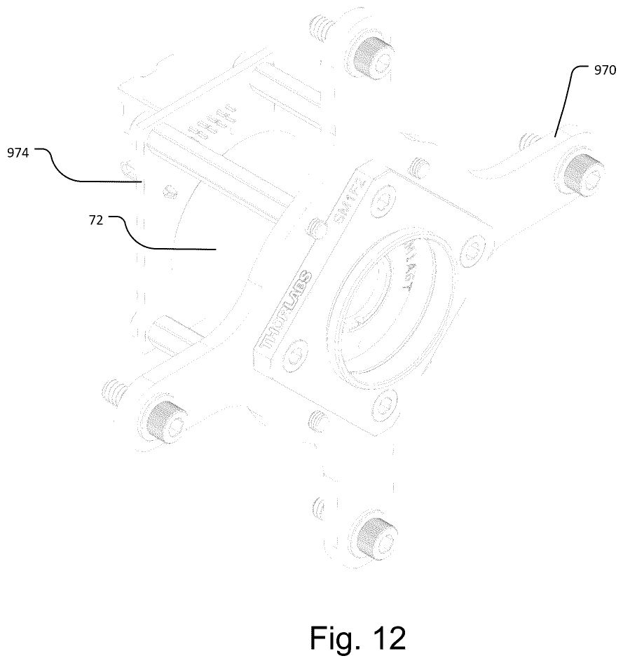

FIG. 12 is a perspective view of the sample detector assembly. It comprises the detector 72 that is mounted inside the detector explosion proof enclosure 600B using a detector mounting plate 970. Also provided is a detector transimpedance amplifier board 974 for amplifying the output from the sample detector 72 for later digitization by the DAC system 20 enabling it to be monitored by the host computer 22.

While this invention has been particularly shown and described with references to preferred embodiments thereof, it will be understood by those skilled in the art that various changes in form and details may be made therein without departing from the scope of the invention encompassed by the appended claims.

What is claimed is:

1. A spectroscopy system, comprising:
an explosion proof enclosure;
a tunable laser in the explosion proof enclosure for generating an output beam for transmission through a sample cell.

2. The spectroscopy system of claim 1, wherein the output beam is transmitted through a window of the explosion proof enclosure to the sample cell.

3. The spectroscopy system of claim 1, further comprising a coupler for coupling a window of the explosion proof enclosure to the sample cell.

4. The spectroscopy system of claim 1, wherein the tunable laser tunes a wavelength of the output beam over the band including 1600 to 1700 nanometers.

5. The spectroscopy system of claim 1, wherein the spectroscopy system operates in a transflection mode.

6. The spectroscopy system of claim 1, further comprising a host computer in the explosion proof enclosure.

7. A spectroscopy method, comprising:
providing a tunable laser for generating an output beam for transmission through a sample cell; and
installing the tunable laser in an explosion proof enclosure.

8. The spectroscopy method of claim 7, wherein the output beam is transmitted through a window of the explosion proof enclosure to the sample cell.

9. The spectroscopy method of claim 7, further comprising using a coupler for coupling a window of the explosion proof enclosure to the sample cell.

10. The spectroscopy method of claim 7, wherein the tunable laser tunes a wavelength of the output beam over the band including 1600 to 1700 nanometers.

11. A spectroscopy system, comprising:
a tunable laser generating an output beam;
a pointing system for directing the output beam;
a sample detector for detecting the output beam after interaction with a sample; and
a controller system configured to operate the pointing system to direct the output beam to the sample detector.

12. The spectroscopy system of claim 11, wherein the controller system is configured to monitor a signal from the sample detector and automatically adjust the pointing system to optimize alignment of the output beam.

13. A spectroscopy method, comprising:
generating an output beam;
directing the output beam with a pointing system;
detecting the output beam after interaction with a sample; and
operating the pointing system to direct the output beam to the sample detector.

14. The method of claim 13, further comprising monitoring a signal from a sample detector and automatically adjusting the pointing system to optimize alignment of the output beam on the sample detector.
